(19) United States
(12) Patent Application Publication
(10) Pub. No.: US 2021/0293718 A1
(43) Pub. Date: Sep. 23, 2021

(54) Biomarker Detection and Detergent Compounds

(71) Applicant: Reynardo Elliott, Harker Heights, TX (US)

(72) Inventor: Reynardo Elliott, Harker Heights, TX (US)

(21) Appl. No.: 17/195,834

(22) Filed: Mar. 9, 2021

Related U.S. Application Data
(60) Provisional application No. 62/990,622, filed on Mar. 17, 2020.

(51) Int. Cl. G01N 21/78; C11D 1/72; C11D 1/66; C11D 1/88

(52) U.S. Cl. CPC G01N 21/78; C11D 1/883; C11D 1/662; C11D 1/721

(57) ABSTRACT

A biomarker detection and detergent compound for use in a toilet. The biomarker detection and detergent compound comprises a biomarker detecting component and a detergent combined as a solid tablet. The tablet is positional in the tank of a toilet similar to other toilet cleaner tablets and will slowly dissolve over several weeks. The biomarker detecting component comprises at least one molecular marker configured to visually show the presence of compounds in urine that indicate a wide range of disorders, such as urinary tract infections, kidney disease and diabetes, and ovulation and pregnancy. The detergent is configured to clean the toilet bowl with each flush without disrupting the urinalysis.

### CROSS-REFERENCE TO RELATED APPLICATION

The present application claims priority to, and the benefit of, U.S. Provisional Application No. 62/990,622, which was filed on Mar. 17, 2020 and is incorporated herein by reference in its entirety.

### FIELD OF THE INVENTION

The present invention generally relates to a way to monitor people for signs of disease or illness, and more specifically to a tablet configured to clean a toilet while simultaneously providing urinalysis. Accordingly, the present specification makes specific reference thereto. However, it is to be appreciated that aspects of the present invention are also equally amenable to other like applications, devices and methods of manufacture.

### BACKGROUND OF THE INVENTION

Individuals often do not know that they are sick until they start experiencing symptoms of a disease. Once symptoms of an illness appear, a medical provider will typically perform tests such as a urinalysis or blood work testing. Unfortunately, the disease or illness may have progressed unnecessarily and may be more difficult to treat. Early detection of conditions such as pregnancy, urinary tract infections, diabetes, etc. is critical to a person's physical health and may even be lifesaving.

Continuous health monitoring is becoming more common in the health and wellness field. Wearables, such as smart watches, are now used to track people's health continuously in real time. This allows an individual or health provider remotely monitoring the biometric data to measure heart rate, detect abnormal heart rhythms, measure respiration and oxygen saturation, among other things. People with diabetes now have continuous blood sugar detection devices that they can use. There are also many single use tests that can use blood or urine to detect abnormalities without going to the doctor.

Urine is a daily produced body fluid that is easily testable for a variety of illnesses and diseases. A urinalysis is a test of your urine. A urinalysis is used to detect and manage a wide range of disorders, such as urinary tract infections, kidney disease and diabetes. A urinalysis involves checking the appearance, concentration, and content of urine. Abnormal urinalysis results may indicate a disease process or illness. To test urine, typically a thin, plastic stick with strips of chemicals on it called a dipstick is placed in the urine to detect abnormalities. The chemical strips change color if certain substances are present or if their levels are above normal.

Dipstick tests are used for to detect many different conditions. They are used to test for an abnormal pH level that would indicate a kidney or urinary tract disorder; increases in the urine protein level indicating kidney problems; the presence of sugar or ketones indicating diabetes; bilirubin indicating liver disease; nitrites or leukocyte esterase indicating a urinary tract infection; or blood indicating kidney damage, infection, kidney or bladder stones, kidney or bladder cancer, or blood disorders. Dipstick tests are colorimetric in nature in that the strip turns a specific color to indicate the presence of a substance. Typically, the darker the color, the more of the test substance is present. Urinalysis is part of routine medical exams and is a good screening tool for wellness.

Additionally, proper sanitation is important to good health. Toilets are contaminated with each use. To stop the spread of germs and disease, toilets must be cleaned on a regular basis. Manual cleaning takes time and is not the most pleasant task. Toilet cleaners now include tablets that the user drops in the tank to automatically sanitize, deodorize, and clean the toilet with every flush. The tablets dissolve in water releasing the cleaning chemicals which are distributed around the bowl when the tank is flushed. Unfortunately, these chemicals may not be compatible with urinalysis testing.

Therefore, there exists a long felt need in the art for a biomarker detection compound. There is also a long felt need for a health monitoring product that looks for signs of disease or illness. Additionally, there is a long felt need in the art for a way to detect a disease or illness before symptom are apparent for use at home on a daily basis. Finally, there is a long felt need in the art for a cleaning agent capable of cleaning a toilet bowl that will not adversely affect simultaneous urinalysis testing.

In this manner, the improved biomarker detection and detergent compound of the present invention accomplishes all of the forgoing objectives, thereby providing an easy solution to continuous health monitoring. The present invention is positional within a toilet for daily use. A primary feature of the present invention a biomarker detecting component for disease or illness detection before symptoms are apparent. The present invention also features a detergent component for keeping the toilet bowl clean.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a urine analysis and detergent composition. The urine analysis and detergent composition comprises a biomarker detecting component and a detergent. The biomarker detecting component and the detergent are combined as a solid tablet. The solid tablet is positional in a toilet tank where it will slowly dissolve in the tank water and leach into the toilet bowl. The urine analysis and detergent composition is configured to provide urinalysis and to simultaneously clean the toilet bowl.

The biomarker detecting component comprises at least one molecular marker for visually indicating the presence of one or more compounds present in a urine sample. The at least one molecular marker is configured to react with the one or more compounds. The reactions produce a change in color that indicates the presence of the one or more compounds present in the urine sample indicating a potential disorder or other health change. The intensity of the color indicates a quantity of the one or more compounds present in the urine.

The at least one molecular marker may be configured to detect and indicate ketonuria, proteinuria, glucosuria, urine nitrates, or leukocyte esterase. The at least one molecular marker detects for compounds in the urine indicating ketonuria, proteinuria, glucosuria, urine nitrates, or leukocyte esterase via an enzymatic or a chemical reaction that generates a dye is a specific color. The at least one molecular marker may be further configured to detect and indicate ovulation or pregnancy. The at least one molecular marker may be any of the at least one molecular markers individually or any combination thereof. A mobile application may be used to monitor and interpret the colorimetry tests and provide information related to the test results.

The detergent is configured to combine with the biomarker detecting component without affecting the urinalysis of the at least one molecular marker. The detergent is further configured to be able to clean the toilet bowl. The detergent may comprise a non-ionic, an ionic, or a zwitterionic formulation.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention demonstrates a urine health indicating toilet bowl cleaning tablet. The tablet is configured to freshen and clean a toilet bowl while providing urinalysis. The tablet comprises a unique chemical makeup designed to assist users in identifying abnormal biomarkers for health conditions commonly detectable in urine. The tablet indicates the presence of certain chemicals or compounds present in urine by changing the color of water. Detectable health conditions include diabetes, pregnancy, dehydration, urinary tract infection, drug testing, and liver disease. A mobile application may be used to monitor and interpret the colorimetry tests and provide information related to the test results.

The tablet is a toilet tank drop-in tablet that freshens and cleans the toilet bowl with each flush while also providing urine analysis for users using color coding. The invention is comprised of a disc toilet cleaner chemical compound that changes color based on a variety of health parameters that can be detected in urine. Each health parameter, such as pregnancy, abnormal amounts of urea, increased glucose, etc. would have a corresponding color that the toilet water would take on once the device is dropped into the toilet tank. For example, if Human Chorionic Gonadotropin (HCG) were detected in the urine, the water would turn purple to indicate pregnancy. If increased glucose is detected, the water will turn pink to indicate diabetes or that the person is prediabetic. An accompanying mobile application would also help users identify what each color means and steps to remedy the specific color indicated ailment. The app may also provide information regarding different ailments and general urine health. The toilet water will stay clear or urine yellow if no significant health issues are triggered by the compound and urine combination.

The present invention, in one exemplary embodiment, is a urine analysis and detergent composition. The urine analysis and detergent composition comprises a biomarker detecting component and a detergent. The biomarker detecting component and the detergent are combined as a solid tablet that is dissolvable in water. The solid tablet is positional in a toilet tank where it will slowly dissolve in the tank water and leach into the toilet bowl. Alternatively, a single use version could be placed directly in the toilet bowl. The urine analysis and detergent composition is configured to provide urinalysis and to simultaneously clean the toilet bowl.

The biomarker detecting component comprises at least one molecular marker for visually indicating the presence of one or more compounds present in a urine sample. The at least one molecular marker is configured to react with the one or more compounds. These reactions produce a change in color that indicates the presence of the one or more compounds present in the urine sample that indicate a potential disorder or other health change. The color is specific to the particular molecular marker. The intensity of the color indicates a quantity of the one or more compounds present in the urine.

The at least one molecular marker may be configured to detect and indicate ketonuria, proteinuria, glucosuria, urine nitrates, or leukocyte esterase. The at least one molecular marker detects for compounds present in the urine indicating ketonuria, proteinuria, glucosuria, urine nitrates, or leukocyte esterase via an enzymatic or a chemical reaction that generates a dye is a specific color.

Ketosis is a metabolic state characterized by elevated levels of ketone bodies in the blood or urine. Urine test strips utilize a nitroprusside reaction with acetoacetate to give a semi-quantitative measure based on color change of the strip. Although beta-hydroxybutyrate is the predominant circulating ketone, urine test strips only measure acetoacetate. In the present invention, the molecular marker for detecting ketonuria may be acetoacetate, acetone, or beta-hydroxybutyrate. Acetoacetate or acetone is combined with sodium nitroprusside to detect ketones. Rothera's test uses sodium nitroprusside activated by basic pH to generate an active compound that reacts with methyl ketones (CH3C(=0)-) to produce a bright red color. Gerhardt's test uses ferric chloride combined with acetoacetate (AcAc) to form a complex with iron ions producing a purple dye. Beta-hydroxybutyrate produced from AcAc employs an enzymatic colorimetric assay using B-HB dehydrogenase (B-HBD) and Diaphorase to yield NADH which reduces WST-5 (yellow colorimetric reagent) to Formazan producing a blue/purple dye.

Table 1 lists the ingredients of one embodiment of the biomarker detecting component configured to detect ketonuria, as well as the weight percent of each ingredient. This is only one possible embodiment and the biomarker detecting component is in no way limited to list of ingredients.

TABLE 1

| Ketone detection (acetoacetate/acetone, | final concentration | |
|---|---|---|
| pink-purple) | (in powder) | |
| Sodium nitroprusside | 400 | mg (5% of total mass) |
| Glycine | 2.5 | g (31% of total mass) |
| Disodium hydrogen phosphate | 4 | g (51% of total mass) |
| Lactose | 1 | g (13% of total mass) |

| | |
|---|---|
| acetoacetate or acetone | 20 mg/dL or 200 mg/L |

Table 2 lists the ingredients of one embodiment of the biomarker detecting component configured to detect ketonuria, as well as the weight percent of each ingredient. This is only one possible embodiment and the biomarker detecting component is in no way limited to list of ingredients.

TABLE 2

| Ketone detection (b-hydroxybutyrate, purple) | final concentration |
|---|---|
| Tris-HCl, pH 8.5 | 100 mM |
| B-HB dehydrogenase | variable |
| WST-1 | unknown |
| Diaphorase | unknown |
| b-hydroxybutyrate | 0-0.5 mM |
| NADH (testing) | variable |

Proteinuria is the presence of excess proteins in the urine. In healthy persons, urine contains very little protein; an excess is suggestive of illness. In the present invention, the molecular marker for detecting proteinuria may be neutrophil gelatinase associated lipocalin (NGAL), N-acetyl-B-glucosaminidase (NAG), Cystatin C, A1-microglobulin, Immunoglobulin G or M, Type 4 collagen, Nephrin, Angiotensinogen, or liver-type fatty acid.

Glycosuria is the excretion of glucose into the urine. Ordinarily, urine contains no glucose because the kidneys can reabsorb all of the filtered glucose from the tubular fluid back into the bloodstream. Glycosuria is nearly always caused by elevated blood glucose levels, most commonly due to untreated diabetes mellitus. In the present invention, the molecular marker for detecting glycosuria is typically D-glucose, or another reducing sugar such as fructose or galactose. An enzyme based colorimetric assay depends on glucose oxidase to form hydrogen peroxide, which reacts with TMB catalyzed by HRP to form TMB/diimine producing a blue color.

Table 3 lists the ingredients of one embodiment of the biomarker detecting component configured to detect glycosuria, as well as the weight percent of each ingredient. This is only one possible embodiment and the biomarker detecting component is in no way limited to list of ingredients.

TABLE 3

| Glucose detection (blue) | final concentration | |
|---|---|---|
| Glucose oxidase | 1-15 | mg/mL |
| Horseradish peroxidase | 100 | ng/mL |
| 3,3′,5,5′-Tetramethylbenzidine (!) | 2 | mg/mL |
| Hydrogen peroxide (testing) | 0.75% | (v/v) |

| | |
|---|---|
| D-glucose | Variable, start with 0.1 mg/mL |

Nitrituria is the existence of nitrites in urine. Nitrituria indicates the presence of a gram negative organism in urine that can indicate a urinary tract infection. In the present invention, the molecular marker for detecting urine nitrite is nitrite. A reagent based (Greiss reagent) test utilizing the reactivity of nitrite for sulfanilamide in acidic pH is used to generate diazonium salt, which reacts with a chromophore to produce an azo dye producing a pink/purple color.

Tables 4 and 5 list the ingredients of embodiments of the biomarker detecting component configured to detect nitrituria, as well as the weight percent of each ingredient. This is only one possible embodiment and the biomarker detecting component is in no way limited to list of ingredients.

TABLE 4

| Nitrite detection (red) | final concentration (in powder) |
|---|---|
| p-Nitroaniline | 2% (of total mass) |
| Chromotropic acid | 2% (of total mass) |
| Potassium chloride | 4% (of total mass) |
| Potassium bromide | 12% (of total mass) |
| Disodium EDTA | 0.4% (of total mass) |
| Malonic acid | 79.6% (of total mass) |
| Acetone | Depending on total mass |
| Nitrite | Variable, start with 0.5 mg/L |

TABLE 5

| | final | |
|---|---|---|
| Nitrite detection (purple) | concentration | |
| N-(1-naphthyl) ethylenediamine | 0.5 | mg/mL |
| dihydrochloride | | |
| Sulfanilic acid | 5 | mg/mL |

| | |
|---|---|
| H3PO4 | 2.50% |
| Nitrite | Variable, start |
| | with 5 uM |

Leukocyte esterase (LE) is an esterase produced by leukocytes (white blood cells). A leukocyte esterase test (LE test) is a urine test for the presence of white blood cells and other abnormalities associated with infection. White blood cells in the urine can indicate a urinary tract infection. In the present invention, the molecular marker for detecting white blood cells in urine is leukocyte esterase. The reaction is based on LE enzyme which converts indoxyl acid ester to indoxyl which reacts with diazonium salt to produce a purple color.

Table 6 lists the ingredients of one embodiment of the biomarker detecting component configured to detect white blood cells, as well as the weight percent of each ingredient. This is only one possible embodiment and the biomarker detecting component is in no way limited to list of ingredients.

TABLE 6

| Leukocyte esterase detection (purple) | final concentration | |
|---|---|---|
| Leukocyte esterase | variable | |
| Borate-NaOH buffer pH 9 (Boric acid, NaOH) | 400 | mM |
| polyvinylpyrrolidone K-30 | 2% | (w/v) |
| Bioterge AS-40 ® | 0.2% | (w/v) |
| NaCl | 250 | mM |
| 3-hydroxyl-5-phenyl-pyrrole-N-tosyl-L-alanine | 1.1 | mM |
| (indoxyl ester) | | |
| 1-diazo-2-naphthol-4-sulfonic acid (diazonium salt) | 0.7 | mM |
| n-decanol | 1.5% | (v/v) |
| Alternative diazonium salt | | |
| 2-[(5-carboxy-2-pyridyl)azo]-1-naphthol-4-sulfonic | | |
| acid (orange) | | |

The at least one molecular marker may be further configured to detect and indicate ovulation or pregnancy. Pregnancy tests are immunoassays utilizing lateral-flow to produce an indicator spot. The flow of the molecular marker (hCG) binds to a colorimetric antibody (Gold-labeled hCG antibody for pregnancy), that together binds to the immobilized hCG antibody, fixed onto a strip or dipstick. Molecules of hCG bound to Gold-antibody are essentially concentrated onto one spot on the dipstick allowing visualization. In the present invention, the molecular maker for detecting pregnancy is human chorionic gonadotropin (hCG). Immunoassay lateral flow, gold-coupled hCG antibodies (brown) bound to hCG capture onto surface of unlabeled hCG antibodies. Therefore, a positive control is IgG immobilized on surface

Because the immunoassay does not involve a color-generating chemical reaction (such as for nitrite or ketones) and relies on concentrating the biomarker for detection, pregnancy detection would be ambiguous if it were incorporated into the tablet formulation (since it would diffuse rather than concentrate). However, the immunoassay can be simply incorporated by putting a small test circle on either side of the tablet with two dot indications (one test and one control). It would not likely interfere with the other reagents in the tablet. The tablet is directly dropped into toilet bowl after urination.

As an alternative to detecting pregnancy, ovulation detection (PdG biomarker) could be incorporated. Ovulation tracking requires daily monitoring of hormone levels, which makes the toilet tablet a suitable platform. Ovulation detection kits also utilize lateral flow immunoassays. In the present invention, the molecular maker for detecting pregnancy is Progesterone (PG) or its metabolite, pregnanediol-3-glucuronide (PdG), Estrogen metabolite, estrone-3-glucuronide (EG), or Luteinizing hormone (LH). Detection is via an immunoassay based test similar to hCG.

Table 7 lists the ingredients of one embodiment of the biomarker detecting component configured to ovulation, as well as the weight percent of each ingredient. This is only one possible embodiment and the biomarker detecting component is in no way limited to list of ingredients.

TABLE 7

| hCG detection (brown) | final concentration |
|---|---|
| human chorionic gonadotropin | variable (suggested 0-1 ng/mL) |
| hCG antibody (against alpha subunit) | 100 ug/mL in 50 mM PBS, pH 7.4 |
| gold or chromophore-labeled | 100 ug/mL in 50 mM PBS, pH 7.4 |
| hCG antibody (against beta subunit) | |

Tables 8 and 9 list a plurality of the molecular markers of one embodiment of the biomarker detecting component configured to provide a urinalysis. This is only one possible embodiment and the biomarker detecting component is in no way limited to this combination of molecular markers. The at least one molecular marker may be any of the at least one molecular markers individually or any combination thereof.

TABLE 8

Possible indication:
Diabetes

| Symptom: | Glycosuria | Ketouria |
|---|---|---|
| Symptom | Glucose (blue) | Ketone, acetoacetate with |
| marker: | | nitroprusside (pink purple) |
| | | Ketone, B-HB (purple) |
| | | Ketone, acetoacetate with |
| | | nitroprusside (pink purple) |

TABLE 9

| | Possible indication: | | | |
|---|---|---|---|---|
| | UTI | | | |
| | | Leukocyte | Pregnancy OR | |
| Symptom: | Urine nitrite | esterase | ovulation | |
| Symptom | Nitrite (red or | | hCG (brown) | LH/PdG/EG |
| marker: | purple) | | | |
| | | LE (purple) | hCG (brown) | LH/PdG/EG |
| | Nitrite (red) | | hCG (brown) | LH/PdG/EG |
| | Nitrite (red or | | hCG (brown) | LH/PdG/EG |
| | purple) | | | |

The detergent is configured to combine with the biomarker detecting component without affecting the urinalysis of the at least one molecular marker. The detergent is further configured to be able to clean the toilet bowl. The detergent may comprise a non-ionic, an ionic, or a zwitterionic surfactant formulation. Non-ionic surfactants are beneficial as they generally do not denature proteins and can disrupt protein-protein interactions. Zwitterionic surfactants are beneficial as they generally do not denature proteins. Ionic surfactants tend to denature proteins but are good cleaning agents that disrupt lipid membranes and fats. The most important parameter of the detergent is compatibility with the biomarker detecting component when combined to not adversely affect the urinalysis.

Table 10 lists ingredients of different formulations of the detergent, as well as the detergent type. These possible embodiments are in no way limited to this list of ingredients. Additionally, the detergent may be any of the at detergent formulations individually or any combination thereof.

TABLE 10

| | |
|---|---|
| Surfactant | Type |

Non-ionic

| | |
|---|---|
| Brij-35 | Polyethylene glycol ester, |
| | powder, non-ionic |
| octyl glucose neopentyl glycol | Powder, non-ionic |
| octyl-glycoside | Glycosidic surfactant, |
| | powder, non-ionic |
| n-dodecyl-beta-D-maltoside | Glycosidic surfactant, |
| | powder, non-ionic |
| n-undecyl-beta-D-maltoside | Glycosidic surfactant, |
| | powder, non-ionic |
| digitonin | steroidal glycoside |
| | surfactant, non-ionic |
| Poloxamers (eg. 188, 171) | non-ionic, polymer |
| | surfactant |
| Polysorbate 20/Tween-20 | Liquid, non-ionic |
| Polysorbate 80/Tween-80 | Liquid, non-ionic |
| Triton X-100 | Liquid, non-ionic |
| Nonidet-40/Igepal CA-630 | Liquid, non-ionic |

Zwitterionic

| | |
|---|---|
| CHAPS (3-cholamidopropyl | Zwitterionic, powder |
| dimethylammonio | |
| 1-propanesulfonate) | |

Ionic

| | |
|---|---|
| sodium cholate | Anionic salt/surfactant, |
| | powder |
| Sarkosyl/N-lauroylsarcosinate | Anionic surfactant, powder |
| sodium salt | |
| sodium dodecyl sulfate | Anionic surfactant, powder, |
| | harsh detergent |

Notwithstanding the forgoing, the urine analysis and detergent composition tablet can by any suitable size, shape, and configuration as is known in the art without affecting the overall concept of the invention, provided that it accomplishes the above stated objectives. One of ordinary skill in the art will appreciate that the shape and size of the urine analysis and detergent composition and its various components described are for illustrative purposes only, and that many other shapes and sizes of the tablet are well within the scope of the present disclosure.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A urine analysis and detergent composition for use in a toilet comprising:
a biomarker detecting component comprising at least one molecular marker for visually indicating the presence of one or more compounds present in a urine sample;
a detergent; and
wherein the biomarker and detergent are combined as a solid tablet.

2. The urine analysis composition of claim 1, wherein the detergent is a non-ionic detergent.

3. The urine analysis composition of claim 1, wherein the at least one molecular marker is configured to react with the one or more compounds so that a change in color indicates the presence of the one or more compounds present in a urine sample and an intensity of the color indicates a quantity of the one or more compounds present.

4. The urine analysis composition of claim 1, wherein the detergent comprises polyethylene glycol dodecyl ether (Brij-35).

5. The urine analysis composition of claim 1, wherein the detergent comprises octyl glucose neopentyl glycol.

6. The urine analysis composition of claim 1, wherein the detergent comprises a glycosidic surfactant.

7. The urine analysis composition of claim 1, wherein the least one molecular marker is configured to detect ketonuria.

8. The urine analysis composition of claim 1, wherein the least one molecular marker is configured to detect glycosuria.

9. The urine analysis composition of claim 1, wherein the least one molecular marker is configured to detect urine nitrite.

10. The urine analysis composition of claim 1, wherein the least one molecular marker is configured to detect urine white blood cells.

11. The urine analysis composition of claim 1, wherein the least one molecular marker is configured to detect pregnancy.

12. The urine analysis composition of claim 1, wherein the least one molecular marker is configured to detect ovulation.

13. The urine analysis composition of claim 1, wherein the least one molecular marker is configured to detect proteinuria.

14. A urine analysis and detergent composition for use in a toilet comprising:
a biomarker detecting component comprising at least one molecular marker for visually indicating the presence of one or more compounds present in a urine sample;
a detergent with a zwitterionic formulation; and
wherein the biomarker and detergent are combined as a solid tablet.

15. The urine analysis composition of claim 14, wherein the detergent comprises 3-[(3-cholamdopropyl) dimethylammonio]-1-propanesulfonate (CHAPS).

16. The urine analysis composition of claim 14, wherein the at least one molecular marker is configured to indicate the presence of ketonuria, glycosuria, or a urinary tract infection.

17. The urine analysis composition of claim 14, wherein the at least one molecular marker is configured to indicate pregnancy or ovulation.

18. A urine analysis and detergent composition for use in a toilet comprising:
a biomarker detecting component comprising at least one molecular marker for visually indicating the presence of one or more compounds present in a urine sample;
a detergent with an ionic formulation; and
wherein the biomarker and detergent are combined as a solid tablet.

19. The urine analysis composition of claim 18, wherein the detergent comprises an anionic surfactant.

20. The urine analysis composition of claim 18, wherein the at least one molecular marker is configured to indicate the presence of ketonuria, glycosuria, urine nitrite, or leukocyte esterase.
